(19) United States
(12) Patent Application Publication
(10) Pub. No.: US 2003/0061144 A1
(43) Pub. Date: Mar. 27, 2003

(54) Controlled access to identification and status information

(76) Inventors: Ernie F. Brickell, Portland, OR (US); Wesley Deklotz, Portland, OR (US)

Correspondence Address: PILLSBURY WINTHROP, LLP, P.O. BOX 10500, MCLEAN, VA, 22102, US

(21) Appl. No.: 09/963,675

(22) Filed: Sep. 27, 2001

(51) Int. Cl. G06F 17/60

(52) U.S. Cl. 705/37

(57) ABSTRACT

A method for controlling access to user information is presented. A user requests a service from a relying party. The relying party makes a request for user information. The user approves or rejects the request for user information. The verification service sends a response to the relying party. As such, the user may selectively control what information is released to, and acquired by, the relying party.

### BACKGROUND

1. Field

This invention relates in general to Internet or other network based authentication. More specifically, this invention relates to a method and system for controlling access to information.

2. General Background and Related Art

In the age of electronic transactions, a party to a transaction often must reveal confidential or sensitive information to another party to the transaction. For instance, a user may have to furnish a service provider with information that proves that the user is qualified to receive the service or has the resources to pay for the service. The service provider may be termed a relying party; the service provider relies on the furnished information to justify doing business with the user.

A host of service providers abounds on the Internet. Some providers offer services to licensed professionals, such as physicians, dentists, attorneys, accountants, and professional engineers. In particular, a provider of services to physicians may need to verify that a user has a medical license in some state, acquire the user's Drug Enforcement Administration (DEA) license number, or verify that no sanctions have been imposed on the DEA license. However, physicians typically do not want such information to become public.

A digital certificate is an electronic “identity card” that establishes a user's credentials when the user participates in a transaction on the World Wide Web (WWW). Issued by a certification authority (CA), a digital certificate may conform to promulgated standards, such as the X.509 PUBLIC KEY INFRASTRUCTURE (PKI) FOR THE INTERNET, see, e.g., RFC 2459. It may be stored in a publicly accessible registry. As such, relying parties, for authentication purposes, can access information contained in the user's certificate.

FIG. 1 (Prior Art) illustrates an exemplary digital certificate 100 of a user. Certificate 100 comprises various information, such as the user's public key 110, security ID 120, other information 130, and a certification authority signature 170. Certificate 100 and a certification authority may be integral components of a public key infrastructure (PKI), which enables users of an unsecure public network to securely and privately exchange information.

Other information 130 in certificate 100 may include information relating to a user. In the case of a licensed professional, other information 130 may include license status 140, state of licensure 150, and license number 160. In certificate 100, all identifying information for the user is contained within the certificate. Because the certificate is publicly available, the user's identifying information is public as well. For users who wish to shield certain information from the public, certificate 100 is not a safe or desirable vehicle in which to convey such information.

A relying party that requests status information about certificate 100 may only obtain information about the status of certificate 100 as a whole. That is, a relying party may ascertain whether certificate 100 is valid or invalid (revoked), but may not ascertain whether subsets of the information in certificate 100 are valid or invalid. For example, a user may be assigned a new license number. Before a new certificate is issued, although the user continues to have a valid license—license status 140 in certificate 100 is valid—certificate 100 is invalid because license number 160 is incorrect. Yet, a relying party may be justified in doing business with a licensed user irrespective of the user's license number, such as where the criteria is that a user simply holds a valid license. If, however, the relying party must also know the user's specific license number, then the relying party will not be able to do business with the user. Thus, the framework of certificate 100 is such that a relying party cannot extract meaningful information about selected information within certificate 100.

Moreover, all information in certificate 100 is static. In order to modify even one item of information therein, a certification authority must revoke certificate 100 and issue an entirely new certificate.

Therefore, what is needed is a method and system for controlling access to user information.

### BRIEF DESCRIPTION OF THE DRAWINGS

FIG. 1 (Prior Art) illustrates an exemplary prior art digital certificate.

FIG. 2 illustrates elements of a public key infrastructure according to an embodiment of the present invention.

FIG. 3 is a high-level diagram of a system according to an embodiment of the present invention.

FIG. 4 illustrates a verification service according to an embodiment of the present invention.

FIG. 5 is a high-level flow diagram of a method according to an embodiment of the present invention.

FIG. 6 is a high-level flow diagram of a method according to an embodiment of the present invention.

FIG. 7 is a high-level flow diagram of a method according to an embodiment of the present invention.

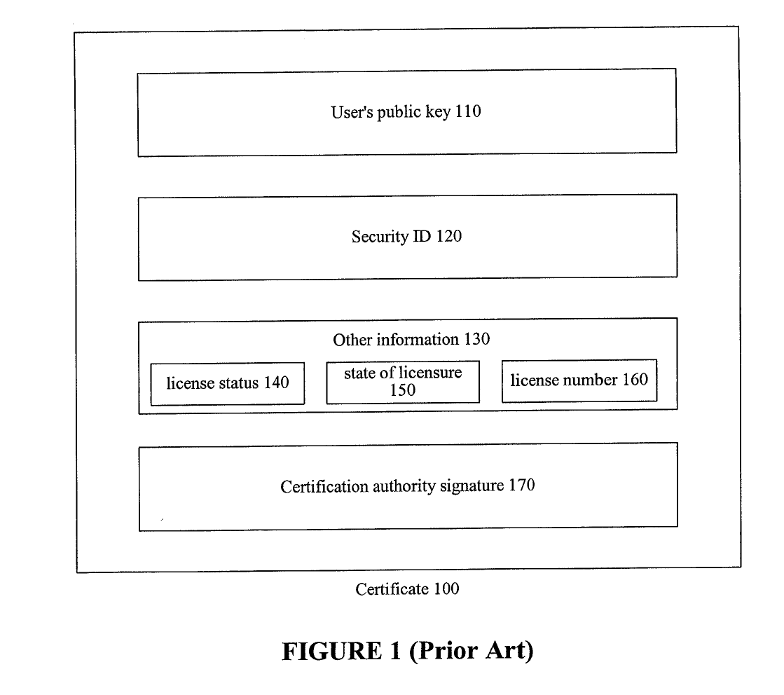

### DETAILED DESCRIPTION

The following detailed description refers to the accompanying drawings that illustrate exemplary embodiments of the present inventions. Other embodiments are possible and modifications may be made to the embodiments without departing from the spirit and scope of the invention. Therefore, the following detailed description is not meant to limit the invention. Rather, the scope of the invention is defined by the appended claims.

It will be apparent to one of ordinary skill in the art that the embodiments as described below may be implemented in many different embodiments of software, firmware, and hardware in the entities illustrated in the figures. The actual software code or specialized control hardware used to implement the present invention is not limiting of the present invention. Thus, the operation and behavior of the embodiments will be described without specific reference to the actual software code or specialized hardware components. The absence of such specific references is feasible because it is clearly understood that artisans of ordinary skill would be able to design software and control hardware to implement the embodiments of the present invention based on the description herein with only a reasonable effort and without undue experimentation.

Moreover, the processes associated with the presented embodiments may be stored in any storage device, such as, for example, a computer system (non-volatile) memory, an optical disk, magnetic tape, or magnetic disk. Furthermore, the processes may be programmed when the computer system is manufactured or via a computer-readable medium at a later date. Such a medium may include any of the forms listed above with respect to storage devices and may further include, for example, a carrier wave modulated, or otherwise manipulated, to convey instructions that can be read, demodulated/decoded and executed by a computer.

A method and system for controlling access to user information, as presented herein, involves a user, a relying party, and a verification service. A user may comprise a person or entity, such as a professional or an organization, as well as a process running on a computer. The user requests a service from the relying party. The relying party makes a request for user information. The user approves or rejects the request for user information. The verification service sends a response containing the released information to the relying party. As such, the user may selectively control what information is released to, and acquired by, the relying party.

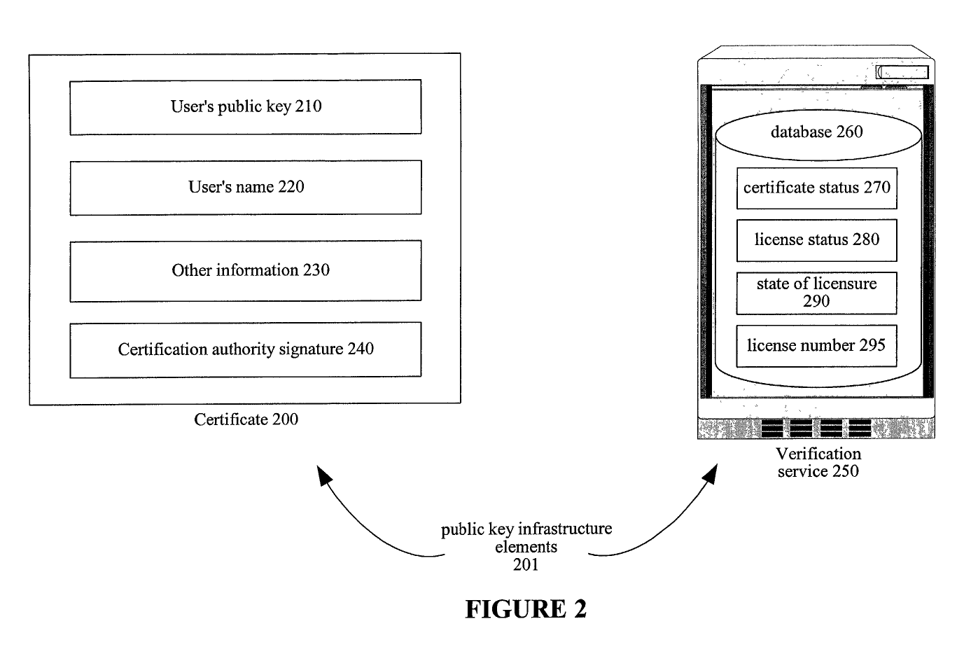

FIG. 2 illustrates elements 201 of a public key infrastructure (PKI) according to an embodiment of the present invention. It is to be appreciated that some embodiments need not include PKI components. For instance, authentications and approvals may be based on other authentication mechanisms, such as password or biometrics mechanisms. PKI elements 201 include a certificate 200, a verification service 250, and a certification authority (not shown). Certificate 200 includes various items of information, such as, for example, a user's public key 210, a user's distinguished name 220, other information 230, and a certification authority signature 240. A user's distinguished name 220 may include, for example, the name of the user, the organization that employs the user, and other information about the user that is useful to uniquely identify the user.

Verification service 250 includes a database 260. Database 260 need not be maintained within verification service 250, but may reside at another location accessible thereto. In other embodiments, database 260 may comprise multiple databases located at various locations.

Database 260 stores any information associated with a user, such as certificate status 270, license status 280, state of licensure 290, and license number 295. Information pertaining to multiple credentials may be stored. However, database 260 may store information unrelated to credentials, such as a user's e-mail address, billing address and credit card number. According to embodiments of the present invention, various information is safely stored within database 260, but not within publicly accessible certificate 200. Thus, such information may be shielded from the public by verification service 250.

In database 260, certificate status 270 indicates whether certificate 200 is valid or has been revoked. License status 280 indicates various status information about a user's license, such as whether the license is valid or sanctioned, or when the license was applied for, issued, or renewed. State of licensure 290 indicates the state or governmental body that issued the license. License number 295 is the license number of the user or a truncated or modified version thereof. In some implementations, database 260 need not include license number 295 because of preferences of a user, conventional practices within the user's field, or legal prohibitions against the dissemination of the number. A single user may have multiple licenses stored in database 260.

In a representative implementation, a certification authority or other entity that issues certificate 200 need not revoke certificate 200 if certain information associated with a user becomes invalid or incorrect. For instance, if information within database 260, such as license number 295, is found to be incorrect, the certification authority may maintain the validity of certificate 200, and the verification service may correct license number 295.

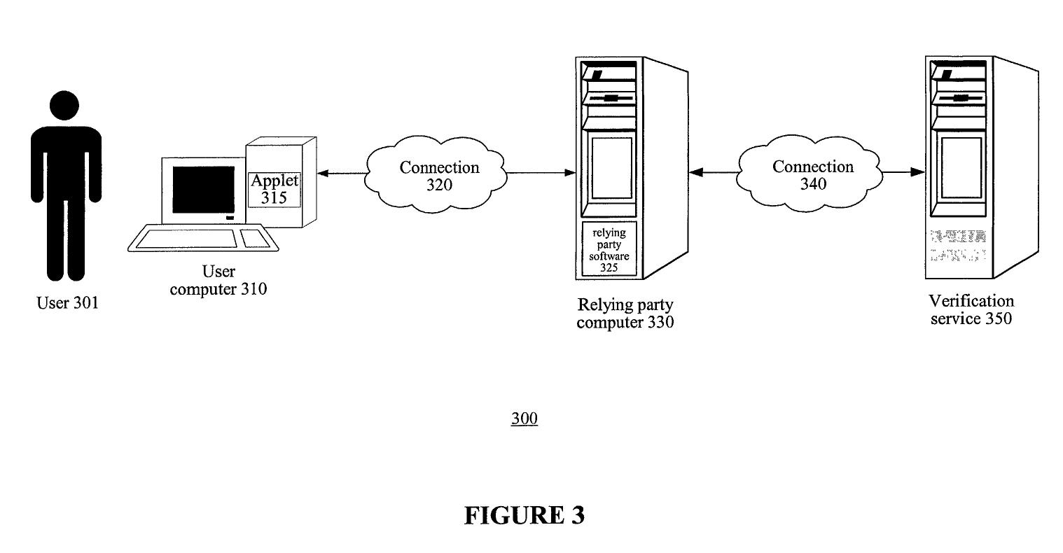

FIG. 3 illustrates system 300 according to an embodiment of the present invention. System 300 comprises a user computer 310 associated with a user 301, a relying party computer 330 associated with a relying party, and a verification service 350. A certification authority (not shown) may issue one or more certificates to a user, such as user 301, and place those certificates in a publicly accessible registry.

User computer 310 communicates with relying party computer 330 over a connection 320, and relying party computer 330 communicates with verification service 350 over a connection 340. Connections 320, 340 may comprise intranet or Internet network connections, whether cabled, wireless, or fiber optic.

User computer 310 may include an applet 315 or an application program. Applet 315 may comprise software installed on a Web browser of user 301. Applet 315 allows user 301 to approve or deny the release of his or her information to a relying party. In one embodiment, user 301 may sign, using a signature key of user 301, a request for user information sent by a relying party and send the signed request back to the relying party. In another embodiment, user 301 may enter a password to approve the release of the information. The signature or password assures verification service 350 that user 301 is willing to release user information to the relying party.

Relying party computer 330 hosts or controls a website offering services to users such as user 301. Relying party computer 330 includes relying party software 325. When the relying party needs access to user information of user 301, relying party software 325 sends an approval request to user 301 for release of information. Additionally, relying party software 325 sends and receives the request for user information, when approved and returned by user 301, to verification service 350. Relying party computer 330 may include an access control system (not shown) to receive as input and retain user information of user 301 returned from verification service 350. As such, relying party computer 330 may use the retained user information for various types of service requests made by user 301 at various times.

Verification service 350 may comprise a server and a database. The server and database portions may reside on separate systems. The server portion of verification service 350 responds to a request for user information forwarded by a relying party. The database portion of verification service 350 may contain any kind of information, such as identification, license, and sanction information associated with a professional. Verification service 350 and a certification authority may be implemented in an integrated system or on separate systems.

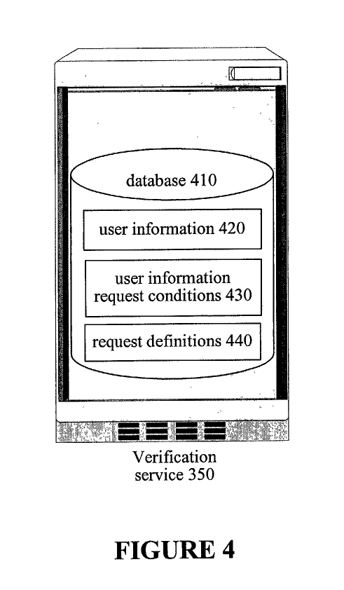

FIG. 4 illustrates verification service 350 according to an embodiment of the present invention. Verification service 350 includes a database 410, which may store and maintain a host of information, such as user information 420, user information request conditions 430, and request definitions 440. User information 420 may include information associated with a given user, such as license status, state of licensure, and sanction information.

Request definitions 440 define types of information requests that are supported by verification service 350, such as requests for user information, requests to verify user information, or requests for the status of user licenses. Request definitions 440 may define an application programmatic interface (API) for relying party software 325 to use when making information requests. In some implementations, a relying party may request that verification service 350 create, delete, or modify request definitions. Administrators of verification service 350 or software on verification service 350 may then take action in response to the request.

Via user information request conditions 430, a user may restrict release of the user's information to only those relying parties whom the user has authorized to receive the information. User information request conditions 430 may specify, for each type of information request and/or for each relying party, conditions which must be satisfied before verification service 350 will furnish items of user information to a relying party. User information request conditions 430 may relate to any kind of condition. Exemplary conditions include: (1) unlimited access, wherein a relying party is allowed to receive an item of information at any time; (2) limited access, wherein a relying party is allowed to receive only items specifically identified by the user; (3) no access, wherein the relying party is never allowed to receive information; and (4) transaction dependent, wherein the relying party is allowed to receive information only if the user timely approves release of the information to the relying party, such as through use of the user's digital signature.

Additional exemplary user information request conditions include: (5) service request dependent, wherein the relying party is allowed to receive information if the user has requested access to one or more services on the relying party's website that require the information; and (6) business arrangement dependent, wherein the relying party is allowed to receive the information if the relying party has an appropriate contractual right granted by verification service 350 or a data provider to verification service 350. User information request conditions 430 may be combined to generate more complex request conditions. Moreover, other conditions may be combined with the above exemplary conditions.

To ensure that system 300 in FIG. 3 is more secure, messages sent between the components of system 300 may be sent encrypted. A PKI may be implemented in systems such as system 300 such that each party has a private signature key and a certificate signed by a certification authority that is trusted by other parties and by verification service 350. As such, messages may be signed to authenticate the source of messages. However, if a PKI is absent, and parties do not have signature keys, embodiments of the present invention may still be implemented using trusted parties and password-based authentication to authenticate the source of messages.

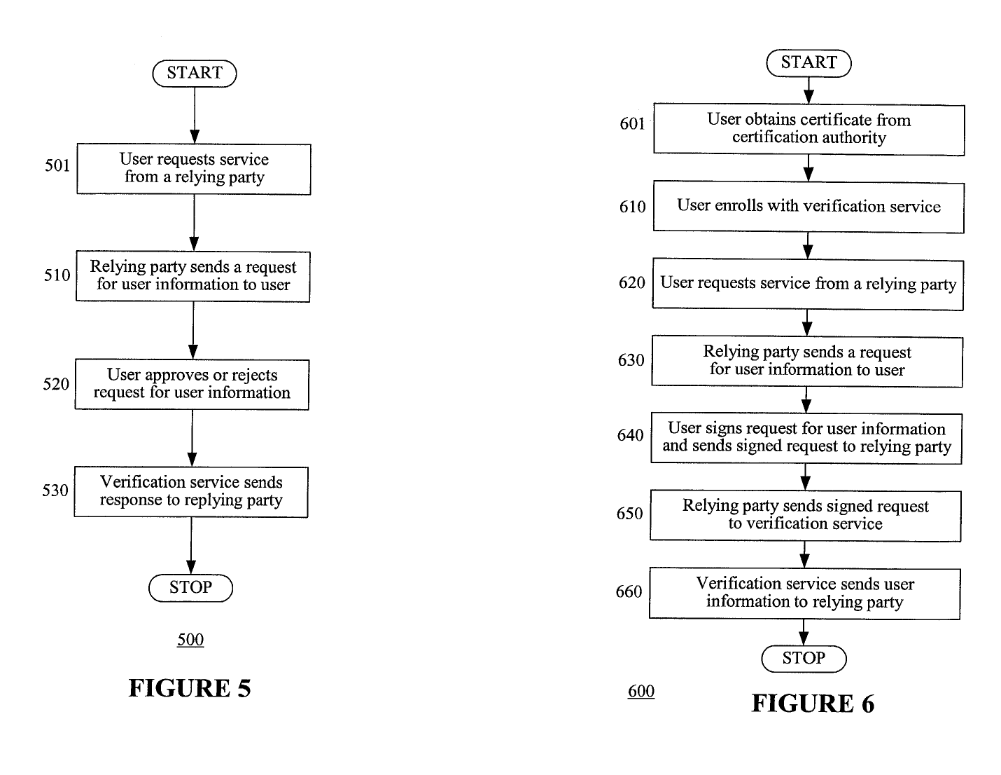

FIG. 5 illustrates method 500 according to an embodiment of the present invention. In item 501, a user requests a service from a relying party. In item 510, the relying party sends a request for user information to the user. In item 520, the user approves or rejects the request for user information. In item 530, the verification service sends a response to the relying party.

FIG. 6 illustrates method 600 according to an embodiment of the present invention. In item 601, a user obtains a certificate from a certification authority. In item 610, the user enrolls with a verification service. In some implementations, items 601 and 610 may occur together to increase efficiency.

During enrollment with the verification service, the user may specify user information request conditions. The user may later modify these conditions on an ad hoc basis. In another embodiment, a user may select a default option which assigns, for example, service request dependent conditions to relying parties. In yet another embodiment, at the time he or she requests a certificate from a certification authority, a user may be informed that the user can also enroll concurrently in the verification service with a default option.

In item 620, the user requests a service from a relying party. More specifically, the user may, via the user's Web browser, visit a website of the relying party. The user may request a service that can be provided only if the relying party successfully verifies the user's credentials.

In item 630, the relying party sends a request for user information to the user. A request for user information may describe the access and the user information that are being requested by the relying party. For example, the request may relate to a particular license among several licenses held by the user. However, if user information request conditions in the verification service do not require a user signature or other approval, then item 630 may be omitted from method 600.

In an exemplary implementation, the relying party may sign the request for user information before sending the request to the user. As such, the user may verify, based on the signature and the certificate of the relying party, that the request did indeed originate with a legitimate relying party. Such a procedure affords additional safeguards for the user information.

In item 640, assuming that the user approves of the release of information, the user may sign the request for user information and send the signed request back to the relying party. This process may be apparent or transparent to the user. A graphical user interface may display to the user the request for information, which the user must approve. In other embodiments, when the user signs the request for user information, the user's signature may also authenticate the user to the relying party.

In another embodiment, a user may provide rules to a program running on the user's computer. Such rules may include, for instance, to always approve requests for information, or to always approve requests from a list of trusted relying parties. Many other types of rules may be used. When a user receives a request for release of information, the request may be handled by the program in accordance with the rules; the user need not be aware of the handling of the request. An additional check may be performed to ensure that the request for information originated from the same organization as that to which the user had made a request for service.

The relying party may then combine the user's signature with the relying party's request for information and sign the result. The relying party's signature assures the verification service that the relying party made the request for information. In some embodiments, a relying party is billed for access to information and/or is potentially liable if private information of the user is released.

In item 650, the relying party sends the signed request to the verification service. The verification service may log the request and check that the signatures are correct and valid. In item 660, the verification service sends user information to the relying party. More specifically, the verification service may prepare, send, and log a signed, time-stamped response to the relying party. If the signatures sent by the relying party are not correct and valid (not shown), then the verification service may deny the request for user information, and may send a response to that effect. In some implementations, upon receipt of the user information, the relying party may check the signature and time-stamp of the verification service before accepting the user information.

It is to be appreciated that the verification service need not log requests and responses or time-stamp responses. However, such procedures may assist a verification service that charges relying parties for providing access to user information. For instance, if the log reflects that the relying party only requested information relating to one license among multiple licenses held by the user, then the verification service may charge the relying party only for furnishing the information actually requested. More generally, the verification service may bill relying parties on any predetermined basis, such as a transactional basis or per user basis. Log information may also be provided to users to assist users in detecting fraudulent requests for, or unauthorized disclosure of, the user's information.

In other exemplary implementations, a user may request that the verification service send the user the user's own information or information request conditions. Accordingly, the user may verify that the information and conditions stored within the verification service are correct.

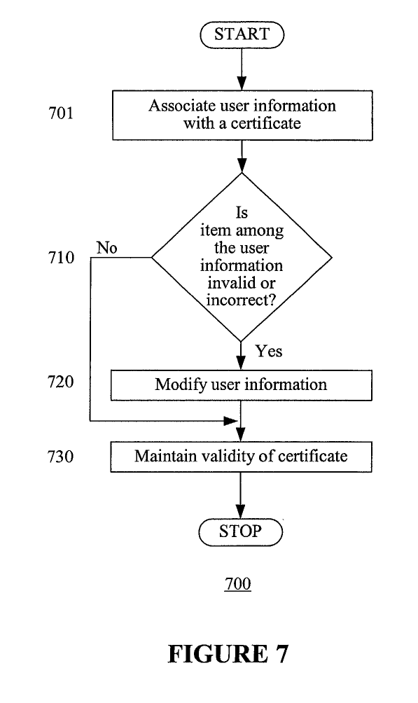

FIG. 7 illustrates method 700 according to an embodiment of the present invention. In item 701, user information is associated with a certificate. This user information is maintained in a location outside of the certificate. In item 710, the method tests whether an item among the user information has become invalid or incorrect. If the item is invalid or incorrect, the user information may be modified in item 720. Conversely, if the information remains valid or correct, the user information is not modified. In either case, the validity of the certificate is maintained in item 730. Thus, a certificate is not revoked needlessly when only specific items of user information become invalid or incorrect.

More particularly, if a user's license has been sanctioned, a user can still use the user's certificate to authenticate the user to services that do not require that the user have a valid license. Because dynamic user information is provided outside of the user's certificate, the user information may be updated by a verification service without the need for a certification authority to issue a new certificate.

The foregoing description of the preferred embodiments is provided to enable any person skilled in the art to make or use the present invention. Various modifications to these embodiments are possible, and the generic principles presented herein may be applied to other embodiments as well.

Embodiments of the present invention may also be applicable where individuals prepare online applications, enroll in organizations, sign up for conferences, etc. Further, individual users may wish to enter into private agreements; confidential or sensitive user information on which agreements are predicated may be stored by a verification service.

Further, the invention may be implemented in part or in whole as a hard-wired circuit, as a circuit configuration fabricated into an application-specific integrated circuit, or as a firmware program loaded into non-volatile storage or a software program loaded from or into a data storage medium as machine-readable code, such code being instructions executable by an array of logic elements such as a microprocessor or other digital signal processing unit.

As such, the present invention is not intended to be limited to the embodiments shown above but rather is to be accorded the widest scope consistent with the principles and novel features disclosed in any fashion herein.

What is claimed:

1. A method for controlling access to user information, comprising:
requesting, by a user, a service from a relying party;
approving or rejecting, by the user, release of user information to the relying party; and
sending, by a verification service to the relying party, a response.

2. The method of claim 1, wherein the user information comprises one of identification information and status information.

3. The method of claim 2, wherein the user information is associated with a licensed professional.

4. The method of claim 1, wherein the approving the request for user information comprises:
signing, by the user, the request for user information;
sending, by the user to the relying party, the signed request for user information; and
sending, by the relying party to the verification service, the signed request for user information.

5. The method of claim 1, further comprising obtaining, by the user, a certificate from a certificate authority.

6. The method of claim 1, further comprising requesting, by the relying party from the verification service, user information.

7. The method of claim 1, wherein at least one of the request for service, the request for user information, and the response is signed.

8. The method of claim 1, wherein the approving the request for user information includes entering, by the user, a password.

9. The method of claim 1, further comprising sending, to the user by the relying party or the verification service, the request for user information.

10. A method for controlling access to user information, comprising:
enrolling, by a user, with a verification service, the enrolling involving at least specifying a predetermined rule;
requesting, by the user, a service from a relying party; and
sending, by the verification service to the relying party, a response,
wherein a release of user information to the relying party depends at least in part on the predetermined rule.

11. The method of claim 10, wherein the enrolling comprises at least one of:
selecting, by the user, user information that can be supplied to a relying party;
selecting, by the user, at least one condition under which user information can be supplied to a relying party; and
selecting, by the user, a default option to affect supplying of user information to a relying party.

12. A method for controlling access to user information, comprising:
sending, by a verification service to a relying party, a response to a request for user information, wherein
a user requests a service from the relying party, and
the user approves or rejects release of user information to the relying party.

13. The method of claim 12, wherein the sending a response comprises one of denying the request for user information and sending the user information.

14. The method of claim 12, further comprising logging, by the verification service, the request for user information and the response.

15. The method of claim 12, further comprising time-stamping, by the verification service, the response.

16. The method of claim 15, further comprising charging a fee to the relying party, by the verification service, for at least one task performed by the verification service.

17. The method of claim 16, wherein the charging includes charging a fee at least in part on a transactional or a per user basis.

18. The method of claim 12, further comprising modifying, by the verification service, user information accessible to the verification service, the modifying not affecting validity of a certificate associated with the user.

19. A method for controlling access to user information, comprising:
making, by a relying party, a request for user information, wherein
the user requests a service from the relying party,
the user approves or rejects release of user information to the relying party, and
a verification service sends a response to the relying party.

20. The method of claim 19, further comprising signing, by the relying party, the request for user information and sending the signed request for user information to the verification service.

21. A method for controlling access to user information, comprising:
providing a certificate for a user;
associating user information with the certificate, the certificate not including the associated user information, at least one item among the user information being sent to a relying party by a verification service; and
modifying the user information when an item among the user information becomes invalid or incorrect,
wherein the certificate for the user remains valid when the item among the user information becomes invalid or incorrect.

22. The method of claim 21, wherein the item includes information relating to a license.

23. A system for controlling access to user information, comprising:
a user computer;
a relying party computer configured to communicate with the user computer over a connection; and
a verification service configured to communicate with the relying party computer over a connection, wherein
the user computer is configured to allow a user to request a service from a relying party,
the relying party is configured to make a request for user information,
the user computer is configured to allow the user to approve or reject release of user information, and
the verification service is configured to send a response to the relying party.

24. The system of claim 23, wherein:
the user computer is further configured to allow the user to sign the request for user information;
the user computer is further configured to allow the user to send the signed request for user information to the relying party; and
the relying party is further configured to send, to the verification service, the signed request for user information.

25. A computer-readable medium encoded with a plurality of processor-executable instructions for:
requesting, by a user, a service from a relying party;
approving or rejecting, by the user, release of user information to the relying party; and
sending, by a verification service to the relying party, a response.

26. The computer-readable medium of claim 25, wherein the user information comprises one of identification information and status information.

27. A computer-readable medium encoded with a plurality of processor-executable instructions for:
sending, by a verification service to a relying party, a response to a request for user information, wherein
a user requests a service from the relying party, and the user approves or rejects release of user information to the relying party.

28. The computer-readable medium of claim 27, wherein the sending a response comprises one of denying the request for user information and sending the user information.

29. A computer-readable medium encoded with a plurality of processor-executable instructions for:
making, by a relying party, a request for user information, wherein
the user requests a service from the relying party,
the user approves or rejects release of user information to the relying party, and
a verification service sends a response to the relying party.

30. The computer-readable medium of claim 29, further comprising processor-executable instructions for signing, by the relying party, the request for user information and sending the signed request for user information to the verification service.
